(19) United States
(12) Patent Application Publication
(10) Pub. No.: US 2024/0201049 A1
(43) Pub. Date: Jun. 20, 2024

(54) SIGNAL PROCESSING DEVICE, SIGNAL PROCESSING METHOD, AND COMPUTERREADABLE STORAGE MEDIUM

(71) Applicant: NEC Corporation, Minato-ku, Tokyo (JP)

(72) Inventors: Sakiko MISHIMA, Tokyo (JP); Yuko OHTA, Tokyo (JP); Reishi KONDO, Tokyo (JP)

(73) Assignee: NEC Corporation, Minato-ku, Tokyo (JP)

(21) Appl. No.: 18/288,104

(22) PCT Filed: May 7, 2021
(86) PCT No.: PCT/JP2021/017459

§ 371 Date: Oct. 24, 2023

(51) Int. Cl. G01M 99/00

(52) U.S. Cl. CPC G01M 99/005

(57) ABSTRACT

A signal processing device according to an aspect of the present disclosure includes: at least one memory configured to store instructions; and at least one processor configured to execute the instructions to: convert an input signal into a predetermined signal in a time-frequency domain; estimate a peak of a time-frequency intensity of the predetermined signal as an intensity of a target signal; estimate a band including at least a bandwidth from a frequency related to a peak to a predetermined frequency and does not include a frequency related to a peak different from the peak, as a noise band that is a frequency band of a noise signal; estimate an intensity of the noise signal based on a time-frequency intensity in the noise band; and determine whether an event has occurred based on a ratio between the intensity of the target signal to the intensity of the noise signal.

### TECHNICAL FIELD

The present disclosure relates to a technique for detecting occurrence of an event from a signal.

### BACKGROUND ART

PTL 1 discloses a technique for detecting occurrence of a specific event from a time-series signal that is a signal related to sound.

PTL 1 discloses a technique for determining a specific sound as a detection target sound and detecting generation of the detection target sound from a mixture of the detection target sound and a background sound different from the detection target sound. Specifically, in the technique disclosed in PTL 1, the detection target sound is detected by determining a target frequency band that is a frequency band of the detection target sound and a control frequency band that is not the frequency band of the detection target sound, and then comparing respective average frequency intensities in the bands.

As a related document, PTL 2 discloses a technique for determining that a target sound is not generated in a target frame of an input signal. Specifically, in the technique disclosed in PTL 2, the power of an enhancement signal that is the target sound in the previous frame is acquired, and if the power is equal to or less than a certain value, it is determined that the target sound is not generated in the target frame.

### CITATION LIST

### Patent Literature

PTL 1: JP 2015-64502 A
PTL 2: WO 2014-136629 A1

### SUMMARY OF INVENTION

### Technical Problem

As an example of a scene where occurrence of an event is detected from an input signal, a scene where abnormal noise generated from various devices such as vehicles including a bullet train, an automobile, and an airplane, and machine tools is detected can be considered. The abnormal sound is a sound different from a sound generated by normal operation of the device, for example. The abnormal sound here may include frictional sound, sliding sound, and the like of a member used in the device. The frequency of such frictional sound or sliding sound changes depending on the type of the member.

According to the technique of PTL 1, it is necessary to set a frequency band and a control frequency band in advance in order to detect the target detection sound. Therefore, if the frequency of the target detection sound varies depending on the type of the member as described above, it is difficult to appropriately set the frequency band. That is, according to the technique of PTL 1, there is a possibility that occurrence of an event cannot be appropriately detected.

The technique in PTL 2 is a technique in a case where the frequency of a target sound signal is known in advance. That is, PTL 2 does not disclose that the target detection sound is detected in a case where the frequency of the target detection sound differs depending on the situation as described above.

The present disclosure has been made in view of the above problems, and an object thereof is to provide a signal processing device and the like capable of appropriately detecting occurrence of an event.

### Solution to Problem

A signal processing device according to an aspect of the present disclosure includes a conversion means for converting an input signal into a predetermined signal that is a signal in a time-frequency domain, a target signal estimation means for estimating a peak of a time-frequency intensity of the predetermined signal as an intensity of a target signal that is a signal related to occurrence of an event, a band estimation means for estimating a band including at least a bandwidth that is from a frequency related to a peak to a predetermined frequency and does not include a frequency related to a peak different from the peak, as a noise band that is a frequency band of a noise signal, a noise signal estimation means for estimating an intensity of the noise signal based on a time-frequency intensity in the noise band, and a determination means for determining whether an event has occurred based on a ratio between the intensity of the target signal to the intensity of the noise signal.

A signal processing method according to an aspect of the present disclosure includes converting an input signal into a predetermined signal that is a signal in a time-frequency domain, estimating a peak of a time-frequency intensity of the predetermined signal as an intensity of a target signal that is a signal related to occurrence of an event, estimating a band including at least a bandwidth that is from a frequency related to a peak to a predetermined frequency and does not include a frequency related to a peak different from the peak, as a noise band that is a frequency band of a noise signal, estimating an intensity of the noise signal based on a time-frequency intensity in the noise band, and determining whether an event has occurred based on a ratio between the intensity of the target signal to the intensity of the noise signal.

A computer-readable storage medium according to an aspect of the present disclosure stores a program for causing a computer to execute converting an input signal into a predetermined signal that is a signal in a time-frequency domain, estimating a peak of a time-frequency intensity of the predetermined signal as an intensity of a target signal that is a signal related to occurrence of an event, estimating a band including at least a bandwidth that is from a frequency related to a peak to a predetermined frequency and does not include a frequency related to a peak different from the peak, as a noise band that is a frequency band of a noise signal, estimating an intensity of the noise signal based on a time-frequency intensity in the noise band, and determining determine whether an event has occurred based on a ratio between the intensity of the target signal to the intensity of the noise signal.

### Advantageous Effects of Invention

According to the present disclosure, occurrence of an event can be appropriately detected.

### BRIEF DESCRIPTION OF DRAWINGS

FIG. 1 is a block diagram illustrating an example of a functional configuration of a signal processing device according to a first example embodiment of the present disclosure.

FIG. 2 is a flowchart illustrating an example of operations of the signal processing device according to the first example embodiment of the present disclosure.

FIG. 3 is a diagram illustrating an example of a signal in a time-frequency domain according to the first example embodiment of the present disclosure.

FIG. 4 is a diagram illustrating an example of a noise band according to the first example embodiment of the present disclosure.

FIG. 5 is a diagram illustrating an example of a relationship between the noise band and frequencies related to peaks according to the first example embodiment of the present disclosure.

FIG. 6 is a flowchart illustrating another example of operations of the signal processing device according to the first example embodiment of the present disclosure.

FIG. 7 is a block diagram illustrating an example of a functional configuration of a signal processing system according to a second example embodiment of the present disclosure.

FIG. 8 is a block diagram illustrating an example of a functional configuration of a signal processing device according to a modification of the present disclosure.

FIG. 9 is a block diagram illustrating an example of a hardware configuration of a computer device that implements each of the devices according to the first and second example embodiments of the present disclosure.

### EXAMPLE EMBODIMENT

Hereinafter, example embodiments of the present disclosure will be described with reference to the drawings.

### First Example Embodiment

A signal processing device according to a first example embodiment will be described.

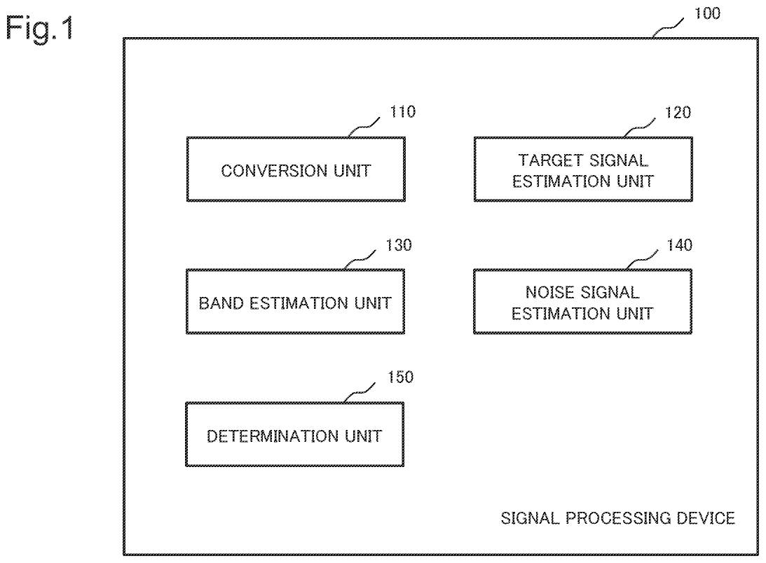

FIG. 1 is a block diagram illustrating an example of a functional configuration of a signal processing device 100 according to the first example embodiment. As illustrated in FIG. 1, the signal processing device 100 includes a conversion unit 110, a target signal estimation unit 120, a band estimation unit 130, a noise signal estimation unit 140, and a determination unit 150.

The conversion unit 110 converts the input signal into a predetermined signal that is a signal in a time-frequency domain. The input signal is a time-series signal input to the signal processing device 100, and is a signal including signals of a plurality of types of sounds, for example. The conversion unit 110 converts the input signal into a signal in the time-frequency domain by using discrete Fourier transform, for example. The conversion unit 110 is an example of a conversion means. In the present disclosure, the signal in the time-frequency domain converted from the input signal will also be called a predetermined signal.

The target signal estimation unit 120 estimates the peak of the time-frequency intensity of a predetermined signal that is a signal in the time-frequency domain, as the intensity of a target signal that is a signal related to the occurrence of an event. For example, the target signal estimation unit 120 detects a peak of the time-frequency intensity of a predetermined signal. The target signal estimation unit 120 sets the detected peak of the time-frequency intensity as the intensity of the target signal, for example. The target signal is a signal related to occurrence of an event. The target signal is a signal of a sound that the user wishes to detect, such as an abnormal sound generated from a device, for example. That is, the target signal estimation unit 120 assumes that the peak of the time-frequency intensity of a predetermined signal is the intensity of the target signal. The target signal estimation unit 120 is an example of a target signal estimation means.

The band estimation unit 130 estimates a band including at least a bandwidth that is from a frequency related to a peak to a predetermined frequency and does not include a frequency related to a peak different from the peak, as a noise band that is a frequency band of a noise signal. The frequency related to the peak may be a frequency corresponding to the peak or a frequency corresponding to a portion from the peak to the tail of the peak, for example. The trail of the peak refers to a rising portion and a falling portion of a waveform indicating the peak. Hereinafter, the frequency corresponding to the peak will also be called peak frequency. The noise signal is a signal indicating a sound different from the target signal. For example, the band estimation unit 130 may estimate a noise band in such a way as to include a band from a peak frequency to an intermediate frequency between a target peak and a peak adjacent to the target peak. For example, the band estimation unit 130 may set the minimum frequency in the noise band to be less than the peak frequency and set the maximum frequency in the noise band to be larger than the peak frequency. The band estimation unit 130 is an example of a band estimation means.

The noise signal estimation unit 140 estimates the intensity of the noise signal based on the time-frequency intensity in the noise band. For example, the noise signal estimation unit 140 estimates a representative value of the time-frequency intensity in the noise band as the intensity of the noise signal. The representative value may be any one of the time-frequency intensities in the noise band, or may be a value obtained by performing a predetermined calculation from the time-frequency intensity in the noise band. If the frequency related to the peak is included in the noise band, the noise signal estimation unit 140 may estimate the intensity of the noise signal, based on the time-frequency intensity of a frequency different from the frequency related to the peak in the noise band, for example. The noise signal estimation unit 140 is an example of a noise signal estimation means.

The determination unit 150 determines whether an event has occurred based on the ratio between the intensity of the target signal and the intensity of the noise signal. For example, the determination unit 150 determines that an event has occurred if the ratio between the intensity of the target signal and the intensity of the noise signal is equal to or greater than a predetermined threshold. At this time, the determination unit 150 may determine that an event has occurred if a value obtained by performing a predetermined calculation on the ratio between the intensity of the target signal and the intensity of the noise signal is equal to or greater than a predetermined threshold. The determination unit 150 is an example of a determination means.

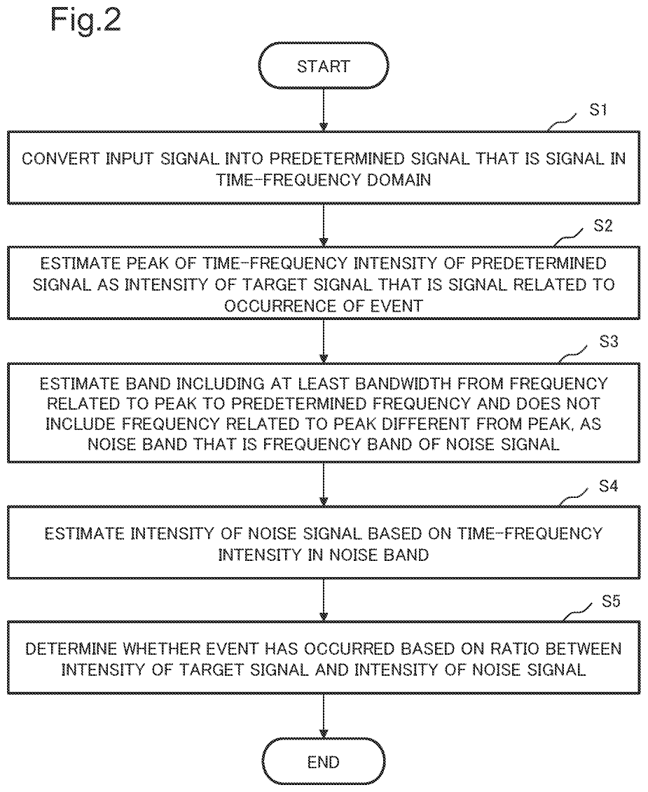

Next, an example of operations of the signal processing device 100 will be described with reference to FIG. 2. In the present disclosure, each step in the flowchart is represented with a number assigned to each step, such as “S1”.

FIG. 2 is a flowchart illustrating an example of operations of the signal processing device 100. The conversion unit 110 converts an input signal into a predetermined signal that is a signal in the time-frequency domain (S1). The target signal estimation unit 120 estimates the peak of the time-frequency intensity of the predetermined signal as the intensity of the target signal that is a signal related to the occurrence of an event (S2). The band estimation unit 130 estimates a band including at least a bandwidth that is from a frequency related to a peak to a predetermined frequency and does not include a frequency related to a peak different from the peak, as a noise band that is a frequency band of a noise signal (S3). The noise signal estimation unit 140 estimates the intensity of the noise signal based on the time-frequency intensity in the noise band (S4). The determination unit 150 determines whether an event has occurred based on the ratio between the intensity of the target signal and the intensity of the noise signal (S5).

The signal processing device 100 of the present disclosure converts an input signal into a predetermined signal that is a signal in a time-frequency domain, and estimates the peak of time-frequency intensity of the predetermined signal as intensity of a target signal that is a signal related to occurrence of an event. The signal processing device 100 further estimates a band including at least a bandwidth that is from a frequency related to a peak to a predetermined frequency and does not include a frequency related to a peak different from the peak, as a noise band that is a frequency band of a noise signal. Then, the signal processing device 100 estimates the intensity of the noise signal based on the time-frequency intensity in the noise band, and determines whether an event has occurred, based on the ratio between the intensity of the target signal and the intensity of the noise signal. In this manner, the signal processing device 100 of the present disclosure can dynamically determine the target signal that is a signal related to the occurrence of an event and the noise signal. Therefore, the signal processing device 100 of the present disclosure can detect the generation of an unknown sound such as a frictional sound or a sliding sound, for example, even if the frequency of the unknown sound changes according to the type of the member in which the sound is generated. That is, the signal processing device 100 of the present disclosure can appropriately detect the occurrence of an event.

### [Another Example of Signal Processing Device 100]

Next, another example of the signal processing device 100 of the present disclosure will be described in detail. Specifically, an example of further functions and operations of each component of the signal processing device 100 in FIG. 1 will be described.

The signal processing device 100 of the present disclosure determines whether an event has occurred, from information of a target signal and a noise signal estimated from an input signal. The target signal means a signal of a target sound. The generation of the target sound is an example of the generation of an event. That is, the signal processing device 100 of the present disclosure determines whether the target sound has been generated from the information of the signal estimated as the target signal. For example, in the above-described scene where an anomalous sound generated from various devices is detected, the anomalous sound is a target sound.

The conversion unit 110 acquires an input signal input to the signal processing device 100. The conversion unit 110 then converts the input signal into a signal in the time-frequency domain. Specifically, the conversion unit 110 cuts out the input signal in predetermined sections. At this time, the conversion unit 110 may cut out a signal in the predetermined sections from the input signal by using a predetermined window function. The conversion unit 110 can cut out a signal in the predetermined sections using a rectangular window, for example. The present disclosure is not limited to this example, and the conversion unit 110 may cut out a signal using another window function such as a Gaussian window, a Hanning window, or a Hamming window. Furthermore, the sections in which a signal is cut out may be different from each other.

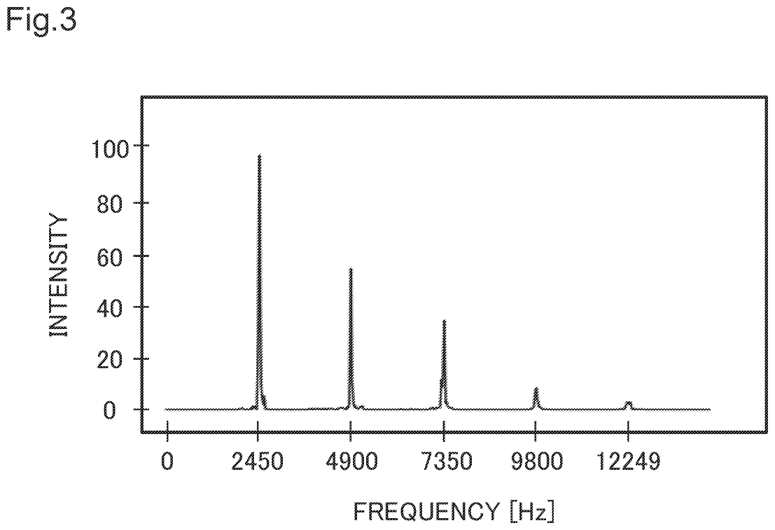

The conversion unit 110 calculates a signal in the frequency domain, that is, a frequency spectrum for the signal cut out from the input signal. At this time, the conversion unit 110 calculates the frequency spectrum by using the discrete Fourier transform for the cut-out signal, for example. The present disclosure is not limited to this example, and the conversion unit 110 may calculate the frequency spectrum using a known method such as wavelet transform. In the present disclosure, a signal in a frequency domain in a certain section of an input signal will be called a signal in the time-frequency domain. FIG. 3 is a diagram illustrating an example of a signal in the time-frequency domain. FIG. 3 is a frequency spectrum at time t indicating a certain section. The horizontal axis of the spectrum in FIG. 3 represents frequency, and the vertical axis represents intensity. At this time, the intensity is amplitude, for example. The intensity is not limited to amplitude, and may be logarithmic amplitude, power, logarithmic power, or the like. In the present disclosure, the intensity of a frequency f at the time t will be called time-frequency intensity and denoted as S(t, f).

The target signal estimation unit 120 estimates the intensity of the target signal from the signal in the time-frequency domain. Specifically, the target signal estimation unit 120 detects a peak of the time-frequency intensity. At this time, the target signal estimation unit 120 may detect the peak by calculating a maximum value using differentiation on the signal in the time-frequency domain, or may detect the peak by searching for a maximum value in a local domain. The target signal estimation unit 120 may detect the peak based on the envelope of the time-frequency intensity. Detecting the peak based on the envelope reduces false detection of the peak due to noise. The method of peak detection is not limited to this example, and another known method may be used.

The target signal estimation unit 120 estimates the peak of the time-frequency intensity as the intensity of the target signal. The intensity of the target signal is defined as S_{Pm}(t, f_{Pm}). Pm represents a peak index. m is an integer of 1 or more, which takes a value up to the number of detected peaks. f_{Pm} represents a peak frequency. That is, the target signal estimation unit 120 estimates the intensity of the target signal for each detected peak. For example, if five peaks are detected, the target signal estimation unit 120 specifies values from S_{P1}(t, f_{P1}) to S_{P5}(t, f_{P5}).

The number of times the intensity of the target signal is estimated may be set in advance. For example, if the number of times the intensity of the target signal is estimated is M (M is an integer of 1 or more), the target signal estimation unit 120 may detect up to M peaks and estimate the intensity of the target signal for each of the detected M peaks. That is, the target signal estimation unit 120 may detect a preset number or less of peaks of the time-frequency intensity of the predetermined signal, and estimate each of the detected peaks as the intensity of the target signal. This makes it possible to prevent deterioration in performance of peak detection due to noise of a signal.

The band estimation unit 130 estimates a noise band at each peak. For example, the band estimation unit 130 sets the minimum frequency and the maximum frequency of the noise band based on the peak frequency. The minimum frequency and the maximum frequency may be intermediate frequencies between a frequency of a target peak and a frequency of a peak adjacent to the target peak. In this case, the minimum frequency is calculated as follows, for example.

$${f}_{N m}^{min} = {f}_{P m - 1} + \frac{{f}_{P m - 1} + {f}_{P m}}{2} \qquad [ Mathematical Formula 1 ]$$

Nm is a noise index. In the case of m=1, f_{P0} may be 0 or may take a value obtained by subtracting a predetermined number from f_{P1}. Similarly, the maximum frequency is calculated as follows, for example.

$${f}_{N m}^{max} = {f}_{P m} + \frac{{f}_{P m} + {f}_{P m + 1}}{2} \qquad [ Mathematical Formula 2 ]$$

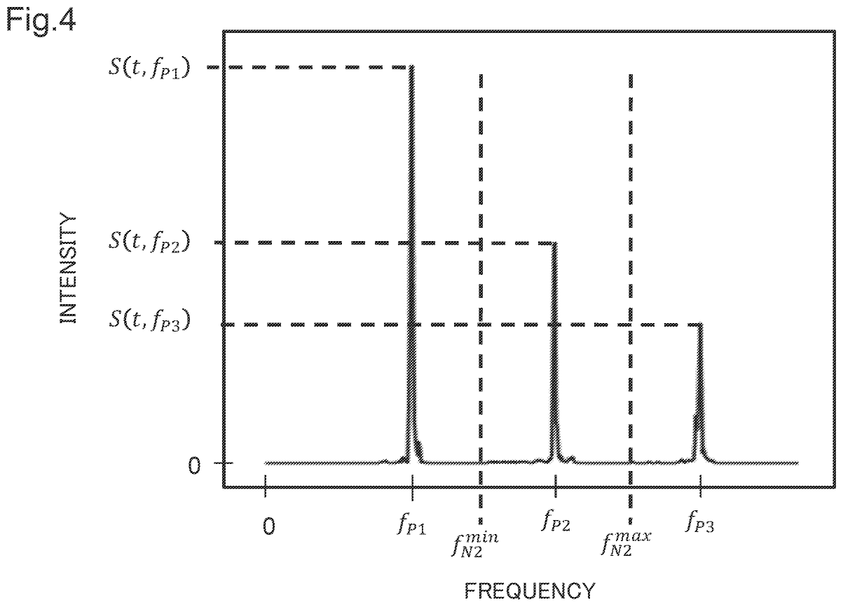

When f_{Pm+1} does not exist, f_{Pm+1} may be set to 0 or a predetermined number. The predetermined number may be a maximum frequency F of the target frequency spectrum, for example. FIG. 4 is a diagram illustrating an example of a noise band. Specifically, FIG. 4 illustrates an example of a noise band with m=2, in which the minimum frequency is set to an intermediate frequency between f_{P1} and f_{P2}, and the maximum frequency is set to an intermediate frequency between f_{P2} and f_{P3}. The band estimation unit 130 estimates a noise band at each peak.

The method of estimating a noise band is not limited to the above example. For example, the minimum frequency of the noise band may be a frequency corresponding to the local minimum value of the time-frequency intensity in the band between f_{Pm} and f_{Pm-1}. For example, the maximum frequency of the noise band may be a frequency corresponding to the local minimum value of the time-frequency intensity in the band between f_{Pm} and f_{Pm+1}. The band estimation unit 130 may set the minimum frequency as the frequency at the bottom of the falling portion in the peak of f_{Pm-1} and set the maximum frequency as the frequency at the bottom of the rising portion in the peak of f_{Pm+1}. The estimated noise band may not include f_{Pm}. The noise band may include at least one of a bandwidth from the frequency at the bottom of the rising portion in the peak of f_{Pm} to a first predetermined frequency and a bandwidth from the frequency at the bottom of the falling portion in the peak of f_{Pm} to a second predetermined frequency. The first predetermined frequency is any frequency between the frequency at the bottom of the rising portion in the peak of f_{Pm} and the frequency at the bottom of the falling portion in the peak of f_{Pm-1}. The second predetermined frequency is any frequency between the frequency at the bottom of the falling portion in the peak of f_{Pm} and the frequency at the bottom of the rising portion in the peak of f_{Pm+1}.

The method of detecting the bottom of a peak may be a method of detecting the bottom of a peak based on fluctuation in the slope of a signal in the time-frequency domain, or may be a method of detecting a local minimum value in the immediate vicinity of a peak as the bottom of the peak. The detection of the bottom of a peak may be performed by the band estimation unit 130 or may be performed by the noise signal estimation unit 140.

The noise signal estimation unit 140 estimates the intensity of the noise signal at each peak based on the time-frequency intensity of the noise band estimated at each peak. For example, the noise signal estimation unit 140 sets the average of the time-frequency intensities in the noise band as the intensity of the noise signal. If a frequency related to a peak is included in the noise band, the noise signal estimation unit 140 calculates the average of time-frequency intensities at frequencies obtained by excluding the peak frequency from the noise band. Assuming that the intensity of the noise signal is S_{Nm}(t), the intensity of the noise signal is calculated as follows, for example.

$${S}_{N m} ( t ) = \frac{1}{( {f}_{N m}^{max} - {f}_{N m}^{min} - 1 )} \times ( {\sum }_{i = {f}_{N m}^{min}}^{{f}_{N m}^{max}} S ( t , i ) - {S}_{P m} ( t , {f}_{P m} ) ) \qquad [ Mathematical Formula 3 ]$$

In this manner, if the minimum frequency of the noise band is less than the frequency related to the peak and the maximum frequency of the noise band is larger than the frequency related to the peak, the noise signal estimation unit 140 may estimate the intensity of the noise signal based on the intensity at the frequency of the band obtained by excluding the peak frequency, which is the frequency corresponding to the peak, from the noise band.

In the example of Equation 3, only the peak frequency is excluded from the noise band. Alternatively, all frequencies related to the peak may be removed from the noise band. That is, the noise signal estimation unit 140 may calculate an average of time-frequency intensities at frequencies with a band excluded from a frequency at the bottom of the rising portion of the peak to a frequency at the bottom of the falling portion of the peak in the noise band. In this case, the intensity of the noise signal is calculated as follows, for example.

$$\begin{matrix}{S}_{N m} ( t ) = \frac{1}{( {f}_{Pm}^{min} - {f}_{N m}^{min} )} {\sum }_{i = {f}_{N m}^{min}}^{{f}_{P m}^{min}} S ( t , i ) + \frac{1}{( {f}_{N m}^{max} - {f}_{P m}^{max} )} {\sum }_{i = {f}_{P m}^{max}}^{{f}_{N m}^{max}} S ( t , i ) \\ {f}_{P m}^{min} : Frequency at bottom of rising portion in peak \\ {f}_{P m}^{max} : Frequency at bottom of falling portion in peak\end{matrix} \qquad [ Mathematical Formula 4 ]$$

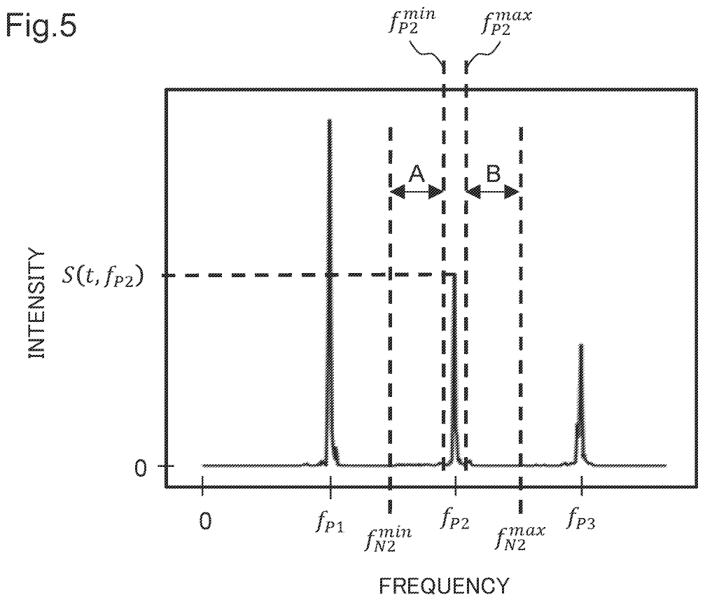

FIG. 5 is a diagram illustrating an example of a relationship between a noise band and a frequency related to a peak. Specifically, FIG. 5 illustrates a noise band and a frequency band related to a peak in a case where the intensity of a noise signal is calculated with m=2. A band A illustrated in FIG. 5 is a band between the minimum frequency of the noise band and the frequency at the bottom of the rising portion of the peak, and a band B is a band between the maximum frequency of the noise band and the frequency at the bottom of the falling portion of the peak. That is, in the case of using Mathematical Formula 4 in the example illustrated in FIG. 5, the noise signal estimation unit 140 obtains an average of time-frequency intensities in the band A and the band B. In this manner, the noise signal estimation unit 140 estimates the intensity of the noise signal based on the intensity at the frequency of the band obtained by excluding the frequency related to the peak (that is, the frequency between the bottom of the rising portion and the bottom of the rising portion of the peak) from the noise band. Accordingly, since the influence of the peak can be removed in calculating the intensity of the noise signal, the intensity of the noise signal can be accurately estimated.

In the above example, the average of the time-frequency intensity in the noise band or the band obtained by excluding the frequency related to the peak from the noise band is calculated. However, the method of calculating the intensity of the noise signal is not limited to this example. For example, the noise signal estimation unit 140 may calculate any one of the minimum value, the mode, and the median of the time-frequency intensity as the intensity of the noise signal, in the noise band or the band obtained by excluding the frequency related to the peak from the noise band.

The determination unit 150 determines whether an event has occurred, based on the ratio between the estimated intensity of the target signal and the intensity of the noise signal. Specifically, the determination unit 150 calculates the ratio between the estimated intensity of the target signal and the intensity of the noise signal for each peak. Assuming that the ratio of the intensity for each peak is S_{Rm}(t), the ratio is calculated as follows, for example.

$${S}_{R m} ( t ) = \frac{{S}_{P m} ( t , {f}_{P m} )}{{S}_{N m} ( t )} \qquad [ Mathematical Formula 5 ]$$

The determination unit 150 calculates a score using the ratio calculated for each peak. For example, the determination unit 150 may use an average of the ratios S_{Rm}(t) as a score. The present disclosure is not limited to this example, and the determination unit 150 may use a weighted average, a maximum value, a minimum value, or the like of the ratios S_{Rm}(t) as a score. If the weighted average of the ratios S_{Rm}(t) is set as a score, assuming that the score is D(t), the score is calculated as follows.

$$D ( □ ) = \frac{1}{□} {\sum }_{□ = 1}^{□} {□}_{□} {□}_{□ □} ( □ ) \qquad [ Mathematical Formula 6 ]$$

where wₘ represents a weight. The weight may be a ratio between the intensities of the target signals in a case where the sum of the intensities of the target signals is 1, or may be a reciprocal of the peak frequency, for example. In this manner, the determination unit 150 may weight the ratio for each peak according to the magnitude of the intensity of the target signal calculated for each peak, and may use the average of the weighted ratios for each peak as a score.

The determination unit 150 determines whether an event has occurred according to the calculated score. For example, assuming that the threshold is θ, the determination unit 150 determines that an event has occurred if D(t)>θ, and determines that no event has occurred if D(t)≤ θ. The threshold θ may be set to any value by the user. For example, an average of scores calculated from input signals in which no event has occurred may be set as the threshold θ. However, the present disclosure is not limited to this example. In this manner, the determination unit 150 calculates the ratio between the intensity of the target signal and the intensity of the noise signal for each peak, and determines that an event has occurred if the score calculated from the ratio for each peak is larger than a threshold.

Determining that an event has occurred shows that the input signal includes a signal of a target sound that the user wishes to detect. For example, in the above-described scene in which abnormal noise generated from various devices is detected, if the score is larger than the threshold, it means that the input signal includes a signal indicating an abnormal noise, that is, an abnormal noise is generated.

### [Operations of Signal Processing Device 100]

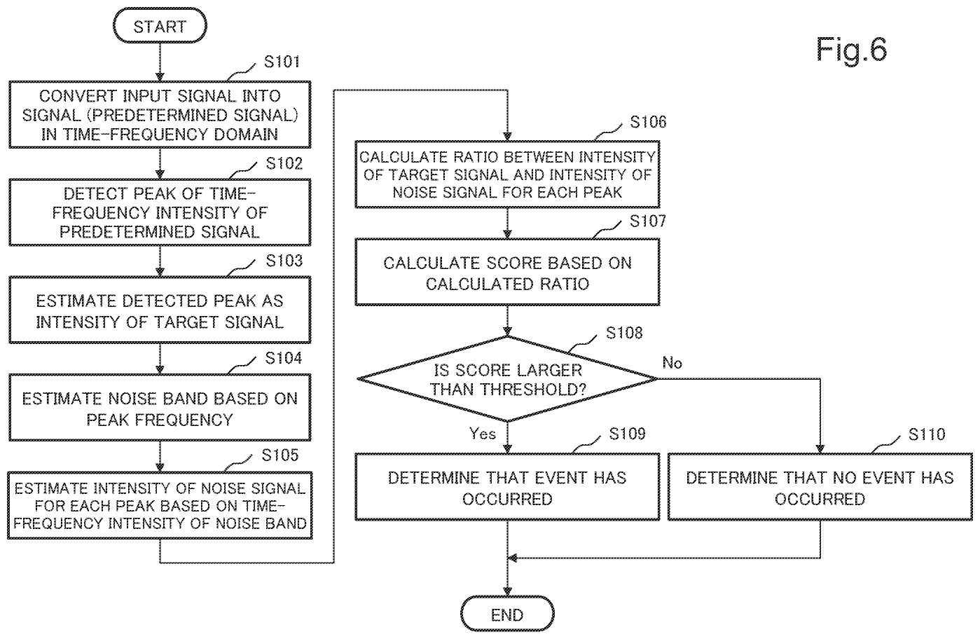

Next, another example of operations of the signal processing device 100 will be described with reference to FIG. 6. FIG. 6 is a flowchart illustrating another example of operations of the signal processing device 100.

First, the conversion unit 110 converts an input signal into a predetermined signal that is a signal in the time-frequency domain (S101). For example, the target signal estimation unit 120 detects a peak of the time-frequency intensity of a predetermined signal (S102). The target signal estimation unit 120 estimates the detected peak as the intensity of the target signal (S103). If a plurality of peaks is detected, the target signal estimation unit 120 estimates each of the peaks as the intensity of the target signal.

Next, the band estimation unit 130 estimates a noise band based on the peak frequency (S104). If a plurality of peaks is detected, the band estimation unit 130 estimates a noise band for each peak. The noise signal estimation unit 140 estimates the intensity of the noise signal for each peak based on the time-frequency intensity of the noise band (S105). If the frequency related to the peak is included in the noise band, the noise signal estimation unit 140 estimates the intensity of the noise signal based on the time-frequency intensity of the band obtained by excluding the frequency related to the peak from the noise band.

The determination unit 150 calculates the ratio between the intensity of the target signal and the intensity of the noise signal for each peak (S106). The determination unit 150 calculates a score based on the calculated ratio (S107). When the score is larger than a threshold (Yes in S108), the determination unit 150 determines that an event has occurred (S109). When the score is larger than the threshold (No in S108), the determination unit 150 determines that no event has occurred (S110).

In this manner, the signal processing device 100 according to the first example embodiment converts an input signal into a predetermined signal that is a signal in a time-frequency domain, and estimates the peak of time-frequency intensity of the predetermined signal as intensity of a target signal that is a signal related to occurrence of an event. The signal processing device 100 further estimates a band including at least a bandwidth that is from a frequency related to a peak to a predetermined frequency and does not include a frequency related to a peak different from the peak, as a noise band that is a frequency band of a noise signal. Then, the signal processing device 100 estimates the intensity of the noise signal based on the time-frequency intensity in the noise band, and determines whether an event has occurred, based on the ratio between the intensity of the target signal and the intensity of the noise signal.

For example, in the case of detecting generation of a specific sound from a sound signal, a method by which to model a frequency pattern of the specific sound and detect the generation of the specific sound based on the model may be used. However, it is difficult to model a frequency pattern of an unknown sound such as a frictional sound and a sliding sound described above in which the frequency varies depending on the type of a member in which the sound is generated. On the other hand, the signal processing device 100 according to the first example embodiment can dynamically determine the target signal that is a signal related to the occurrence of an event and the noise signal. Therefore, the signal processing device 100 can detect the generation of an unknown sound even if the frequency of the unknown sound changes according to the type of the member in which the sound is generated. That is, the signal processing device 100 of the present disclosure can appropriately detect the occurrence of an event.

### Second Example Embodiment

Next, a signal processing system including a signal processing device according to a second example embodiment will be described.

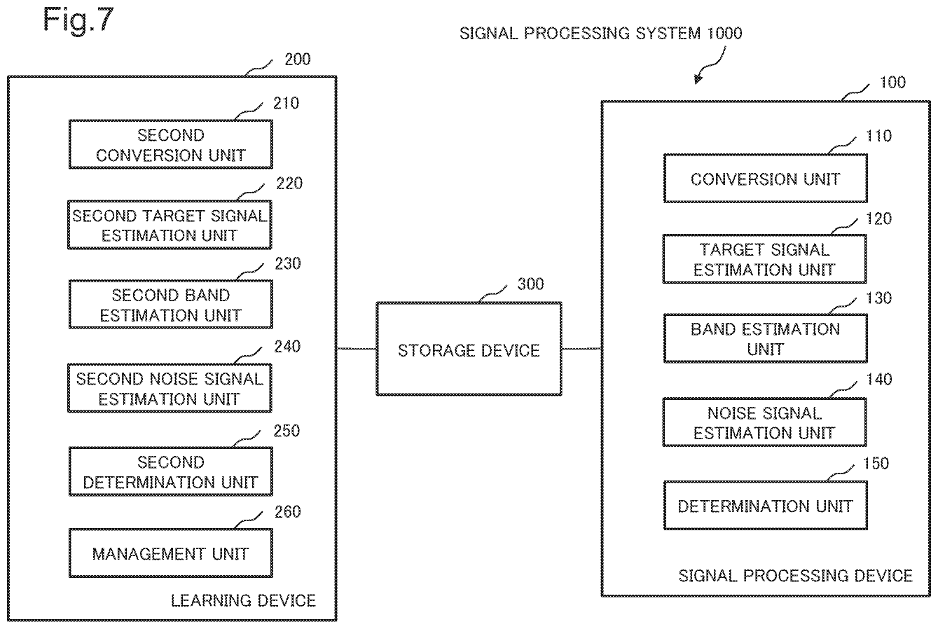

FIG. 7 is a block diagram illustrating an example of a functional configuration of a signal processing system 1000 according to the second example embodiment. As illustrated in FIG. 7, the signal processing system 1000 includes a signal processing device 100, a learning device 200, and a storage device 300. The storage device 300 may be a device integrated with either the learning device or the signal processing device 100. Description of components and operations of the signal processing system 1000 illustrated in FIG. 6 overlapping with those of the first example embodiment will be omitted.

When a signal including a target signal is input, the learning device 200 determines from the input signal whether an event has occurred. That is, the learning device 200 determines whether a target sound (for example, anomalous sound) that the user wishes to detect has been generated in relation to a signal known in advance to include a signal of the target sound. The learning device 200 determines whether an event has occurred by a method similar to that of the signal processing device 100 according to the first example embodiment described above. At this time, the learning device 200 performs each processing with changes in the parameters used for determining whether an event has occurred. The parameters are the number M for estimating the intensity of the target signal, the minimum frequency and the maximum frequency set at the time of estimating the noise band, the threshold θ, and the like, for example, but are not limited to this example. The parameters indicate methods for processing to be performed by the signal processing device 100 and numerical values set for each method. The learning device 200 outputs statistical information on the parameters. The statistical information may include information in which the values of the parameters, the determination results, and information indicating whether the determination results are correct are associated with one another. The statistical information may include an average, a variance, a maximum value, a minimum value, and the like of numerical values of parameters used when the determination results are correct. The statistical information is stored in the storage device 300.

Next, a functional configuration of the learning device 200 will be described. As illustrated in FIG. 7, the learning device 200 includes a second conversion unit 210, a second target signal estimation unit 220, a second band estimation unit 230, a second noise signal estimation unit 240, a second determination unit 250, and a management unit 260. The second conversion unit 210, the second target signal estimation unit 220, the second band estimation unit 230, the second noise signal estimation unit 240, and the second determination unit 250 have the same functions as the conversion unit 110, the target signal estimation unit 120, the band estimation unit 130, the noise signal estimation unit 140, and the determination unit 150, respectively.

For example, the second conversion unit 210 performs processing while changing parameters related to the method of converting an input signal into a signal in a time-frequency domain, such as a method of calculating a frequency spectrum for a section to be cut out from the input signal and the cut out signal. For example, the second target signal estimation unit 220 performs processing while changing the method of peak detection and the number M for estimating the intensity of the target signal. For example, the second band estimation unit 230 performs processing while changing the method of setting the minimum frequency and the maximum frequency of the noise band to be estimated, that is, the width of the noise band. For example, when estimating the intensity of the noise signal, the second noise signal estimation unit 240 performs processing while changing the method of calculating the time-frequency intensity in the noise band. For example, the second determination unit 250 performs processing while changing the method of calculating a score D(t) and a threshold θ.

The management unit 260 outputs statistical information on parameters applied when the second conversion unit 210, the second target signal estimation unit 220, the second band estimation unit 230, the second noise signal estimation unit 240, and the second determination unit 250 perform processing. For example, the management unit 260 may associate the value of each parameter, a determination result, and information indicating whether the determination result is correct, and store them in the storage device 300 as statistical information. The management unit 260 may also store the average, variance, maximum value, minimum value, and the like of the numerical values of the parameters used when the determination results are correct, in the storage device 300, as the statistical information.

As described above, the learning device 200 outputs the statistical information of the parameters used when determining from the second input signal including at least another target signal whether an event has occurred, similarly to the determination means of the signal processing device 100.

The signal processing device 100 performs each processing based on the statistical information stored in the storage device 300. For example, the target signal estimation unit 120 may set the number M for estimating the intensity of the target signal as the maximum value of M included in the statistical information. For example, the band estimation unit 130 may set the minimum value of the width of the noise band included in the statistical information as the upper limit of the width of the noise band to be estimated. For example, the determination unit 150 may set the threshold θ as the maximum value of the threshold θ included in the statistical information.

As described above, the signal processing system 1000 according to the second example embodiment outputs the statistical information of the parameters used when determining whether an event has occurred from the second input signal including at least another target signal, similarly to the determination unit 150 of the signal processing device 100. The signal processing system 1000 sets parameters used when determining from the input signal whether an event has occurred, based on the statistical information. Accordingly, the signal processing system 1000 can determine whether an event has occurred from an unknown input signal using parameters with high determination accuracy, for example.

### Modifications

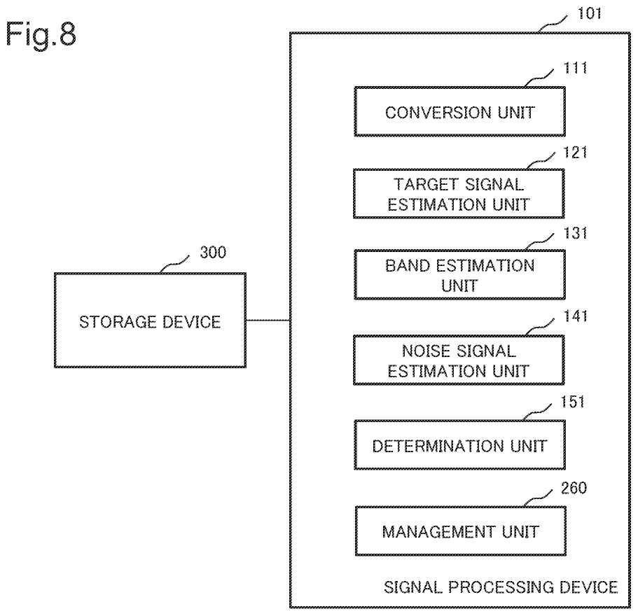

In the second example embodiment, the learning device 200 is a device different from the signal processing device 100 as an example. The signal processing device may perform operations similar to those of the learning device 200. FIG. 8 is a block diagram illustrating an example of a functional configuration of a signal processing device 101 according to a modification. As illustrated in FIG. 8, the signal processing device 101 is communicably connected to a storage device 300. The storage device 300 and the signal processing device 101 may be an integrated device. The signal processing device 101 includes a conversion unit 111, a target signal estimation unit 121, a band estimation unit 131, a noise signal estimation unit 141, a determination unit 151, and a management unit 260. The conversion unit 111, the target signal estimation unit 121, the band estimation unit 131, the noise signal estimation unit 141, and the determination unit 151 have the same functions as those of the conversion unit 110, the target signal estimation unit 120, the band estimation unit 130, the noise signal estimation unit 140, and the determination unit 150, respectively. In addition, the conversion unit 111, the target signal estimation unit 121, the band estimation unit 131, the noise signal estimation unit 141, and the determination unit 151 have the same functions as those of the second conversion unit 210, the second target signal estimation unit 220, the second band estimation unit 230, the second noise signal estimation unit 240, and the second determination unit 250, respectively.

### <Example of Hardware Configuration of Signal Processing Device>

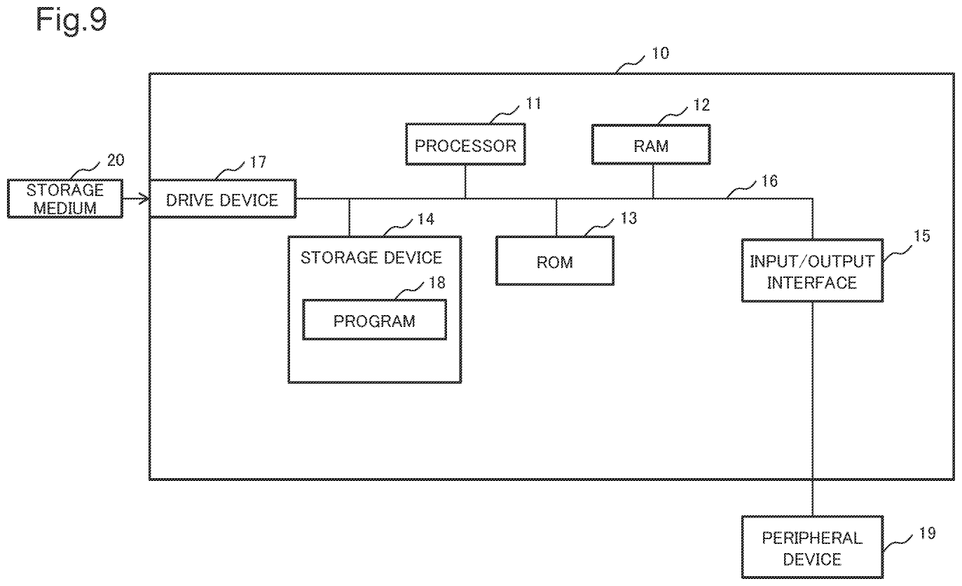

Hardware constituting the signal processing devices according to the first and second example embodiments will be described. FIG. 9 is a block diagram illustrating an example of a hardware configuration of a computer device that implements the signal processing device according to each example embodiment. In the computer device 10, the signal processing device and the signal processing method described according to each example embodiment and modification are implemented. Each of the learning device and the storage device described according to the second example embodiment may also have the hardware configuration illustrated in FIG. 9.

As illustrated in FIG. 9, the computer device 10 includes a processor 11, a random access memory (RAM) 12, a read only memory (ROM) 13, a storage device 14, an input/output interface 15, a bus 16, and a drive device 17. The signal processing device may be implemented by a plurality of electric circuits.

The storage device 14 stores programs (computer programs) 18. The processor 11 executes the programs 18 of the signal processing device using the RAM 12. Specifically, the programs 18 include programs that cause a computer to execute the processing in the signal processing device described in relation to each example embodiment with reference to FIGS. 2, 6, and others, for example. When the processor 11 executes the programs 18, the functions of the components of the signal processing device are implemented. The programs 18 may be stored in the ROM 13. In addition, the programs 18 may be recorded in the storage medium 20 and read using the drive device 17, or may be transmitted from an external device (not illustrated) to the computer device 10 via a network (not illustrated).

The input/output interface 15 exchanges data with peripheral devices (keyboard, mouse, display device, and others) 19. The input/output interface 15 functions as a means for acquiring or outputting data. The bus 16 connects the components.

There are various modifications of the method of implementing the signal processing device. For example, the signal processing device can be implemented as a dedicated device. The signal processing device can be implemented based on a combination of a plurality of devices.

Processing methods for causing a storage medium to record programs for implementing the components in functions of each example embodiment, reading the programs recorded in the storage medium as a code, and executing the programs in a computer are also included in the scope of each example embodiment. That is, a computer-readable storage medium is also included in the scope of each example embodiment. A storage medium in which the above-described programs are recorded and the programs themselves are also included in each example embodiment.

The storage medium is a floppy (registered trademark) disk, a hard disk, an optical disk, a magneto-optical disk, a compact disc (CD)-ROM, a magnetic tape, a nonvolatile memory card, or a ROM, for example, but is not limited to these examples. The programs recorded in the storage medium are not limited to programs for executing processing alone, and programs that operate on an operating system (OS) to execute processing in cooperation with other software and functions of an extension board are also included in the scope of each example embodiment.

Although the present disclosure has been described with reference to the example embodiments, the present disclosure is not limited to the above example embodiments. Various modifications that can be understood by those skilled in the art can be made to the configuration and details of the present disclosure within the scope of the present disclosure.

Some or all of the above example embodiments may be described as the following supplementary notes, but are not limited to the following.

### SUPPLEMENTARY NOTES

### Supplementary Note 1

A signal processing device including
a conversion means for converting an input signal into a predetermined signal that is a signal in a time-frequency domain,
a target signal estimation means for estimating a peak of a time-frequency intensity of the predetermined signal as an intensity of a target signal that is a signal related to occurrence of an event,
a band estimation means for estimating a band including at least a bandwidth that is from a frequency related to a peak to a predetermined frequency and does not include a frequency related to a peak different from the peak, as a noise band that is a frequency band of a noise signal,
a noise signal estimation means for estimating an intensity of the noise signal based on a time-frequency intensity in the noise band, and
a determination means for determining whether an event has occurred based on a ratio between the intensity of the target signal to the intensity of the noise signal.

### Supplementary Note 2

The signal processing device according to Supplementary Note 1, wherein
if a minimum frequency of the noise band is less than the frequency related to the peak and a maximum frequency of the noise band is larger than the frequency related to the peak,
the noise signal estimation means estimates the intensity of the noise signal, based on the intensity at a frequency of a band obtained by excluding a peak frequency, which is a frequency corresponding to the peak, from the noise band.

### Supplementary Note 3

The signal processing device according to Supplementary Note 2, wherein
the noise signal estimation means estimates the intensity of the noise signal, based on an intensity at a frequency of a band obtained by excluding a band of the frequency related to the peak from the noise band.

### Supplementary Note 4

The signal processing device according to any one of Supplementary Notes 1 to 3, wherein
the determination means calculates the ratio between the intensity of the target signal and the intensity of the noise signal for each of the peaks, and determines that an event has occurred if a score calculated based on the ratio is larger than a threshold.

### Supplementary Note 5

The signal processing device according to Supplementary Note 4, wherein
the determination means performs weighting on the ratio for each of the peaks according to a magnitude of the intensity of the target signal calculated for each of the peaks, and sets an average of the weighted ratios for each of the peaks as the score.

### Supplementary Note 6

The signal processing device according to any one of Supplementary Notes 1 to 5, wherein
the target signal estimation means detects a predetermined number or less of the peaks of the time-frequency intensity of the predetermined signal, and estimates each of the detected peaks as the intensity of the target signal.

### Supplementary Note 7

The signal processing device according to Supplementary Note 4 or 5, wherein,
similarly to the determination means, the determination means sets a calculation method of the score and the threshold for a second input signal including at least another target signal, based on statistical information of a parameter used to determine whether the event has occurred.

### Supplementary Note 8

The signal processing device according to Supplementary Note 6, wherein,
similarly to the determination means, the target signal estimation means sets the predetermined number for a second input signal including at least another target signal, based on statistical information of a parameter used to determine whether the event has occurred.

### Supplementary Note 9

The signal processing device according to any one of Supplementary Notes 1 to 8, wherein, similarly to the determination means, the band estimation means estimates the noise band for the second input signal including at least another target signal, based on the statistical information of the parameter used to determine whether the event has occurred.

### Supplementary Note 10

A signal processing system including:
a learning device configured to, similarly to the determination means, output the statistical information of the parameter used to determine whether the event has occurred for the second input signal including at least another target signal,
a storage device that stores the information output by the learning device, and
the signal processing device according to any one of Supplementary Notes 1 to 9.

### Supplementary Note 11

A signal processing method including:
converting an input signal into a predetermined signal that is a signal in a time-frequency domain,
estimating a peak of a time-frequency intensity of the predetermined signal as an intensity of a target signal that is a signal related to occurrence of an event,
estimating a band including at least a bandwidth that is from a frequency related to a peak to a predetermined frequency and does not include a frequency related to a peak different from the peak, as a noise band that is a frequency band of a noise signal,
estimating an intensity of the noise signal based on a time-frequency intensity in the noise band, and
determining whether an event has occurred based on a ratio between the intensity of the target signal to the intensity of the noise signal.

### Supplementary Note 12

The signal processing method according to Supplementary Note 11, further including:
if a minimum frequency of the noise band is less than the frequency related to the peak and a maximum frequency of the noise band is larger than the frequency related to the peak,
estimating the intensity of the noise signal, based on the intensity at a frequency of a band obtained by excluding a peak frequency, which is a frequency corresponding to the peak, from the noise band.

### Supplementary Note 13

The signal processing method according to Supplementary Note 12, further including:
estimating the intensity of the noise signal, based on an intensity at a frequency of a band obtained by excluding a band of the frequency related to the peak from the noise band.

### Supplementary Note 14

The signal processing method according to any one of Supplementary Notes 11 to 13, further including:
calculating the ratio between the intensity of the target signal and the intensity of the noise signal for each of the peaks, and determining that an event has occurred if a score calculated based on the ratio is larger than a threshold.

### Supplementary Note 15

The signal processing method according to Supplementary Note 14, further including:
weighting on the ratio for each of the peaks according to a magnitude of the intensity of the target signal calculated for each of the peaks, and setting an average of the weighted ratios for each of the peaks as the score.

### Supplementary Note 16

The signal processing method according to any one of Supplementary Notes 11 to 15, further including:
detecting a predetermined number or less of the peaks of the time-frequency intensity of the predetermined signal, and estimating each of the detected peaks as the intensity of the target signal.

### Supplementary Note 17

The signal processing method according to Supplementary Note 14 or 15, further including:
similarly to the determining, setting a calculation method of the score and the threshold for a second input signal including at least another target signal, based on statistical information of a parameter used to determine whether the event has occurred.

### Supplementary Note 18

The signal processing method according to Supplementary Note 16, further including:
similarly to the determining, setting the predetermined number for a second input signal including at least another target signal, based on statistical information of a parameter used to determine whether the event has occurred.

### Supplementary Note 19

The signal processing method according to any one of Supplementary Notes 11 to 18, further including:
similarly to the determining, estimating the noise band for the second input signal including at least another target signal, based on the statistical information of the parameter used to determine whether the event has occurred.

### Supplementary Note 20

A computer-readable storage medium storing a program for causing a computer to execute:
converting an input signal into a predetermined signal that is a signal in a time-frequency domain,
estimating a peak of a time-frequency intensity of the predetermined signal as an intensity of a target signal that is a signal related to occurrence of an event,
estimating a band including at least a bandwidth that is from a frequency related to a peak to a predetermined frequency and does not include a frequency related to a peak different from the peak, as a noise band that is a frequency band of a noise signal,
estimating an intensity of the noise signal based on a time-frequency intensity in the noise band, and
determining whether an event has occurred based on a ratio between the intensity of the target signal to the intensity of the noise signal.

### Supplementary Note 21

The computer-readable storage medium according to Supplementary Note 20, wherein
if a minimum frequency of the noise band is less than the frequency related to the peak and a maximum frequency of the noise band is larger than the frequency related to the peak,
the estimating the intensity of the noise signal includes estimating the intensity of the noise signal, based on the intensity at a frequency of a band obtained by excluding a peak frequency, which is a frequency corresponding to the peak, from the noise band.

### Supplementary Note 22

The computer-readable storage medium according to Supplementary Note 21, wherein
the estimating the intensity of the noise signal includes estimating the intensity of the noise signal, based on an intensity at a frequency of a band obtained by excluding a band of the frequency related to the peak from the noise band.

### Supplementary Note 23

The computer-readable storage medium according to Supplementary Note 20 or 21, wherein
the determining includes calculating the ratio between the intensity of the target signal and the intensity of the noise signal for each of the peaks, and determining that an event has occurred if a score calculated based on the ratio is larger than a threshold.

### Supplementary Note 24

The computer-readable storage medium according to Supplementary Note 23, wherein
the determining includes performing weighting on the ratio for each of the peaks according to a magnitude of the intensity of the target signal calculated for each of the peaks, and setting an average of the weighted ratios for each of the peaks as the score.

### Supplementary Note 25

The computer-readable storage medium according to any one of Supplementary Notes 20 to 24, wherein
the estimating the intensity of the target signal includes detecting a predetermined number or less of the peaks of the time-frequency intensity of the predetermined signal, and estimating each of the detected peaks as the intensity of the target signal.

### Supplementary Note 26

The computer-readable storage medium according to Supplementary Note 23 or 24, wherein
the determining includes, similarly to the determining, setting a calculation method of the score and the threshold for a second input signal including at least another target signal, based on statistical information of a parameter used to determine whether the event has occurred.

### Supplementary Note 27

The computer-readable storage medium according to Supplementary Note 25, wherein
the estimating the intensity of the target signal includes, similarly to the determining, setting the predetermined number for a second input signal including at least another target signal, based on statistical information of a parameter used to determine whether the event has occurred.

### Supplementary Note 28

The computer-readable storage medium according to any one of Supplementary Notes 20 to 27, wherein
the estimating the noise band includes, similarly to the determining, estimating the noise band for a second input signal including at least another target signal, based on statistical information of a parameter used to determine whether the event has occurred.

### REFERENCE SIGNS LIST

100, 101 Signal processing device
110, 111 Conversion unit
120, 121 Target signal estimation unit
130, 131 Band estimation unit
140, 141 Noise signal estimation unit
150, 151 Determination unit

What is claimed is:

1. A signal processing device comprising:
at least one memory configured to store instructions; and
at least one processor configured to execute the instructions to:
convert an input signal into a predetermined signal that is a signal in a time-frequency domain;
estimate a peak of a time-frequency intensity of the predetermined signal as an intensity of a target signal that is a signal related to occurrence of an event;
estimate a band including at least a bandwidth that is from a frequency related to a peak to a predetermined frequency and does not include a frequency related to a peak different from the peak, as a noise band that is a frequency band of a noise signal;
estimate an intensity of the noise signal based on a time-frequency intensity in the noise band; and
determine whether an event has occurred based on a ratio between the intensity of the target signal to the intensity of the noise signal.

2. The signal processing device according to claim 1, wherein the at least one processor is further configured to execute the instructions to:
set a minimum frequency of the noise band to be less than the frequency related to the peak and a maximum frequency of the noise band to be larger than the frequency related to the peak; and
estimate the intensity of the noise signal, based on the intensity at a frequency of a band obtained by excluding a peak frequency, which is a frequency corresponding to the peak, from the noise band.

3. The signal processing device according to claim 2, wherein the at least one processor is further configured to execute the instructions to:
estimate the intensity of the noise signal, based on an intensity at a frequency of a band obtained by excluding a band of the frequency related to the peak from the noise band.

4. The signal processing device according to claim 1, wherein the at least one processor is further configured to execute the instructions to:
calculate the ratio between the intensity of the target signal and the intensity of the noise signal for each of the peaks; and
determine that an event has occurred if a score calculated based on the ratio is larger than a threshold.

5. The signal processing device according to claim 4, wherein the at least one processor is further configured to execute the instructions to:
weigh the ratio for each of the peaks according to a magnitude of the intensity of the target signal calculated for each of the peaks; and
set an average of the weighted ratios for each of the peaks as the score.

6. The signal processing device according to claim 1, wherein the at least one processor is further configured to execute the instructions to:
detect a predetermined number or less of the peaks of the time-frequency intensity of the predetermined signal; and
estimate each of the detected peaks as the intensity of the target signal.

7. The signal processing device according to claim 4, wherein the at least one processor is further configured to execute the instructions to:
set a calculation method of the score and the threshold for a second input signal including at least another target signal, based on statistical information of a parameter used to determine whether the event has occurred.

8. The signal processing device according to claim 6, wherein the at least one processor is further configured to execute the instructions to:
set the predetermined number for a second input signal including at least another target signal, based on statistical information of a parameter used to determine whether the event has occurred.

9. The signal processing device according to claim 1, wherein the at least one processor is further configured to execute the instructions to:
set the noise band for the second input signal including at least another target signal, based on the statistical information of the parameter used to determine whether the event has occurred.

10. (canceled)

11. A signal processing method comprising:
converting an input signal into a predetermined signal that is a signal in a time-frequency domain;
estimating a peak of a time-frequency intensity of the predetermined signal as an intensity of a target signal that is a signal related to occurrence of an event;
estimating a band including at least a bandwidth that is from a frequency related to a peak to a predetermined frequency and does not include a frequency related to a peak different from the peak, as a noise band that is a frequency band of a noise signal;
estimating an intensity of the noise signal based on a time-frequency intensity in the noise band; and
determining whether an event has occurred based on a ratio between the intensity of the target signal to the intensity of the noise signal.

12. The signal processing method according to claim 11, further comprising:
setting a minimum frequency of the noise band to be less than the frequency related to the peak and a maximum frequency of the noise band to be larger than the frequency related to the peak; and
estimating the intensity of the noise signal, based on the intensity at a frequency of a band obtained by excluding a peak frequency, which is a frequency corresponding to the peak, from the noise band.

13. The signal processing method according to claim 12, further comprising:
estimating the intensity of the noise signal, based on an intensity at a frequency of a band obtained by excluding a band of the frequency related to the peak from the noise band.

14. The signal processing method according to claim 11, further comprising:
calculating the ratio between the intensity of the target signal and the intensity of the noise signal for each of the peaks; and
determining that an event has occurred if a score calculated based on the ratio is larger than a threshold.

15. The signal processing method according to claim 14, further comprising:
weighting on the ratio for each of the peaks according to a magnitude of the intensity of the target signal calculated for each of the peaks; and
setting an average of the weighted ratios for each of the peaks as the score.

16. (canceled)

17. The signal processing method according to claim 14, further comprising:
similarly to the determining, setting a calculation method of the score and the threshold for a second input signal including at least another target signal, based on statistical information of a parameter used to determine whether the event has occurred.

18-19. (canceled)

20. A non-transitory computer-readable storage medium storing a program for causing a computer to execute:
converting an input signal into a predetermined signal that is a signal in a time-frequency domain;
estimating a peak of a time-frequency intensity of the predetermined signal as an intensity of a target signal that is a signal related to occurrence of an event;
estimating a band including at least a bandwidth that is from a frequency related to a peak to a predetermined frequency and does not include a frequency related to a peak different from the peak, as a noise band that is a frequency band of a noise signal;
estimating an intensity of the noise signal based on a time-frequency intensity in the noise band; and
determining whether an event has occurred based on a ratio between the intensity of the target signal to the intensity of the noise signal.

21. The computer-readable storage medium according to claim 20, wherein
a minimum frequency of the noise band is less than the frequency related to the peak and a maximum frequency of the noise band is larger than the frequency related to the peak, and wherein
the estimating the intensity of the noise signal includes estimating the intensity of the noise signal, based on the intensity at a frequency of a band obtained by excluding a peak frequency, which is a frequency corresponding to the peak, from the noise band.

22. The computer-readable storage medium according to claim 21, wherein
the estimating the intensity of the noise signal includes estimating the intensity of the noise signal, based on an intensity at a frequency of a band obtained by excluding a band of the frequency related to the peak from the noise band.

23. The computer-readable storage medium according to claim 20, wherein
the determining includes calculating the ratio between the intensity of the target signal and the intensity of the noise signal for each of the peaks, and determining that an event has occurred if a score calculated based on the ratio is larger than a threshold.

24. The computer-readable storage medium according to claim 23, wherein
the determining includes performing weighting on the ratio for each of the peaks according to a magnitude of the intensity of the target signal calculated for each of the peaks, and setting an average of the weighted ratios for each of the peaks as the score.

25-28. (canceled)
